(19) United States
(12) Patent Application Publication
(10) Pub. No.: US 2024/0403121 A1
(43) Pub. Date: Dec. 5, 2024

(54) Task Scheduling Based on Component Margins

(71) Applicants: Advanced Micro Devices, Inc, Santa Clara, CA (US); ATI Technologies ULC, Markham (CA)

(72) Inventors: Anil Harwani, Austin, TX (US); Paul Blinzer, Carnation, WA (US); Kenneth Lawrence Mitchell, Austin, TX (US); Adam Neil Calder Clark, Victoria (CA); Amitabh Mehra, Fort Collins, CO (US); Joshua Taylor Knight, Georgetown, TX (US); Grant Evan Ley, Eden, UT (US); Jerry Anton Ahrens, Sister Bay, WI (US); William Robert Alverson, Del Valle, TX (US)

(21) Appl. No.: 18/203,360

(22) Filed: May 30, 2023

(51) Int. Cl. G06F 9/50

(52) U.S. Cl. CPC G06F 9/5027

(57) ABSTRACT

Task scheduling based on component margins is described. In accordance with the described techniques, a scheduler of an operating system accesses a margin table when a request to perform tasks is received. The scheduler schedules tasks on various components of a system based on margins of those components. When a request to perform a task is received, for example, the scheduler accesses the margin table and selects a component to perform the task based on the margin information included in the margin table as well as based on the task, such as whether the task benefits more from being performed fast or being performed accurately. The scheduler then schedules the task using the selected component.

### BACKGROUND

Various components of a computing device are operated according to settings, some of which are adjustable to values that exceed thresholds of operation certified by a manufacturer. Adjusting such settings so that components exceed their certified thresholds is known as “overclocking”. By way of example, a processor consumes very little power while in the idle state, but power consumption increases rapidly when the processor is required to perform an action. Some operations require more power than others, and in cases where higher performance (e.g., throughput) is demanded from a processor, clock rates of the processor can be increased such that the processor is run at a frequency higher than specified. When run at the frequency higher than specified, the processor is overclocked. In another example, a memory can be overclocked by modifying specific parameters of the memory in order to achieve faster operating speeds which improves the performance (e.g., throughput) of a computing device. Overclocking or process marginality generally results in some risk in terms of the correctness of the output generated by components which are being overclocked.

### BRIEF DESCRIPTION OF THE DRAWINGS

FIG. 1 is a block diagram of a non-limiting example system having a scheduler that schedules tasks to components based on margins of the components.

FIG. 2 is a block diagram of a non-limiting example in which a scheduler schedules components to perform tasks based on a mapping of performance objectives associated with the tasks to margins that support achieving those objectives.

FIG. 3 depicts a non-limiting example of a user interface in one or more implementations.

FIG. 4 depicts a procedure in an example implementation of task scheduling based on component margins.

### DETAILED DESCRIPTION

### Overview

Overclocked systems can be unstable for certain use cases because the system is pushed into a higher performance band with the tradeoff that accuracy is reduced thereby causing system instability. This often occurs because conventional operating system schedulers make assumptions that components in a system are guaranteed to generate accurate results. However, because overclocked components sacrifice accuracy for increased performance (e.g., throughput), this assumption made by conventional schedulers causes overclocked systems to often be unstable and prone to crashing because the operating system does not understand which components sacrifice accuracy for performance.

To solve these problems, task scheduling based on component margins is described. In accordance with the described techniques, a scheduler for an operating system has access to margin information for components of the system, and thus is able to determine which components are operating at correct conditions and thus are guaranteed to be accurate and which components are operating beyond their guaranteed conditions (e.g., overclocked components) and should not be trusted to perform tasks where accuracy is important.

In one or more implementations, margin information for a plurality of components of a system is maintained in a margin table of the system. The margin information describes, for each of the plurality of components (e.g., cores of a processor), a margin relative to which the component is capable of operating without errors. A scheduler of the system is configured to schedule tasks on the various components of the system based on margins of those components. Thus, when a request to perform a task is received, the scheduler accesses the margin table and selects a component to perform the task based on the margin information included in the margin table as well as based on the task, such as whether the task benefits more from being performed fast (e.g., video game graphics rendering) or being performed accurately (e.g., game physics). The scheduler then schedules the task using the selected component.

Thus the described techniques provide advantages over conventional schedulers which are unable to determine margin information for different components. Providing the scheduler with access to the margin table containing margin information for components of the system enables the scheduler to provide increased performance for tasks in which performance is critical but accuracy is not essential by scheduling such tasks on components with low marginality, while scheduling tasks that need accuracy and correctness on components with high marginality.

In some aspects, the techniques described herein relate to a system including: a margin table that maintains margin information for a plurality of components of the system, the margin information describing, for each of the plurality of components, a margin for operating without errors, and a scheduler configured to: receive a request to perform one or more tasks, select a component of the plurality of components based on the margin information and the one or more tasks, and schedule performance of the one or more tasks using the selected component.

In some aspects, the techniques described herein relate to a system, wherein the scheduler is further configured to classify the one or more tasks as being associated with accuracy or performance.

In some aspects, the techniques described herein relate to a system, wherein the scheduler selects the selected component with a high margin for operating without errors if the one or more tasks classified as being associated with accuracy.

In some aspects, the techniques described herein relate to a system, wherein the scheduler selects the selected component with a low margin for operating without errors if the one or more tasks are classified as being associated with performance.

In some aspects, the techniques described herein relate to a system, wherein the selected component with the low margin for operating without errors includes an overclocked component.

In some aspects, the techniques described herein relate to a system, wherein the scheduler is configured to classify the one or more tasks as being associated with accuracy or performance based on a type of the one or more tasks.

In some aspects, the techniques described herein relate to a system, wherein the scheduler is further configured to initiate a test of the selected component prior to selecting the component to ensure that the margin of the selected component in the margin table is accurate.

In some aspects, the techniques described herein relate to a system, wherein the plurality of components includes a plurality of processing cores, wherein the plurality of processing cores includes at least one overclocked processing core.

In some aspects, the techniques described herein relate to a system, wherein the selected component includes at least one of a graphics processing unit (GPU) or a memory.

In some aspects, the techniques described herein relate to a system, further including a controller to dynamically adjust a margin of a particular component of the plurality of components to perform at least one task using the particular component with the dynamically adjusted margin.

In some aspects, the techniques described herein relate to a computer-implemented method including: maintaining, in a margin table of a system, margin information for a plurality of components of the system, the margin information describing, for each of the plurality of components, a margin for operating without errors, receiving, by a scheduler, a request to perform one or more tasks, selecting, by the scheduler, a component of the plurality of components based on the margin information of the one or more tasks, and scheduling, by the scheduler, performance of the one or more tasks using the selected component.

In some aspects, the techniques described herein relate to a computer-implemented method, further including classifying, by the scheduler, the one or more tasks as being associated with accuracy or performance.

In some aspects, the techniques described herein relate to a computer-implemented method, further including selecting a component with a high margin for operating without errors if the one or more tasks are classified as being associated with accuracy.

In some aspects, the techniques described herein relate to a computer-implemented method, further including selecting a component with a low margin for operating without errors if the one or more tasks are classified as being associated with performance.

In some aspects, the techniques described herein relate to a computer-implemented method, wherein the selected component with the low margin for operating without errors includes an overclocked component.

In some aspects, the techniques described herein relate to a computer-implemented method, further including testing the selected component prior to selecting the component to ensure that the margin of the selected component in the margin table is accurate.

In some aspects, the techniques described herein relate to a computer-implemented method, wherein the plurality of components includes a plurality of processing cores, wherein the plurality of processing cores includes at least one overclocked processing core.

In some aspects, the techniques described herein relate to a computer-implemented method, wherein the selected component includes a graphics processing unit (GPU).

In some aspects, the techniques described herein relate to a computer-implemented method, wherein the selected component includes a memory.

In some aspects, the techniques described herein relate to a computing device including: a plurality of processing cores, the plurality of processing cores including at least one overclocked processing core, a margin table that maintains margin information for each of the plurality of processing cores, the margin information describing, for each of the plurality of processing cores, a margin for operating without errors, and a scheduler configured to schedule a task using one of the plurality of processing cores based on the margin information maintained in the margin table.

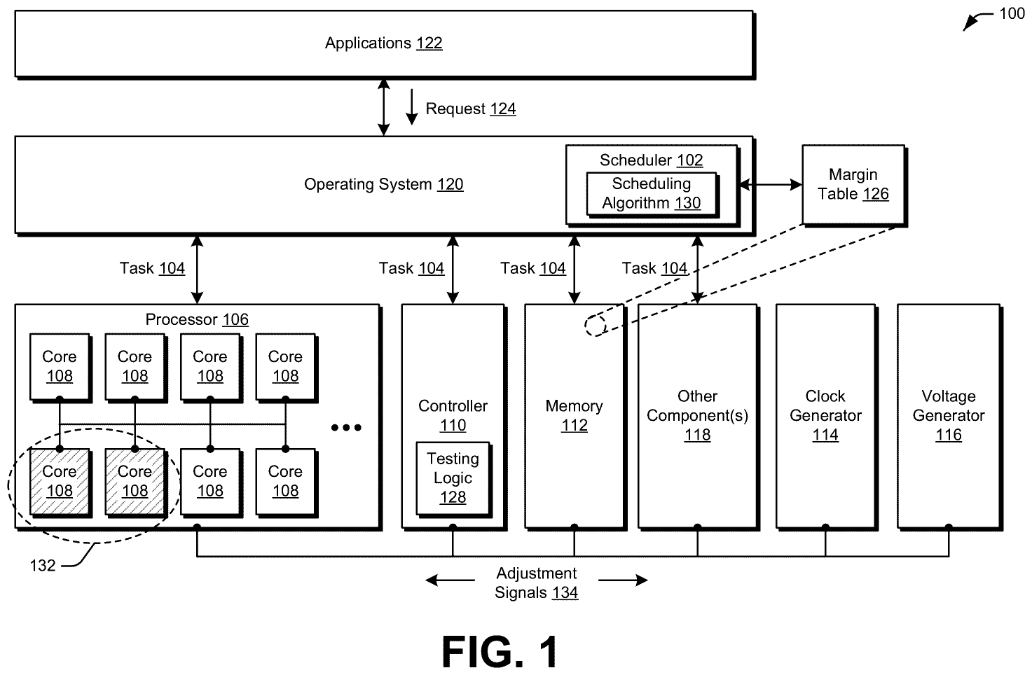

FIG. 1 is a block diagram of a non-limiting example system 100 having a scheduler that schedules tasks to components based on margins of the components. In particular, the system 100 has a variety of components to which a scheduler 102 can schedule tasks 104 based on margins of those components. In this example, for instance, the components include a processor 106, which is depicted having multiple cores 108. Processors having multiple cores (e.g., two or more separate processing units) on a single integrated circuit are commonly referred to as “multi-core processors.” Although depicted with multiple cores in the illustrated example, in one or more implementations, the processor 106 only has a single core 108. In this example, the components of the system 100 also includes a controller 110, a memory 112, a clock generator 114, voltage generator 116, and optionally other component(s) 118. The processor 106, the controller 110, the memory 112, and optionally the other component(s) 118 are operable to implement an operating system 120 and one or more applications 122.

In accordance with the described techniques, the processor 106, the controller 110, the memory 112, the clock generator 114, the voltage generator 116, and the other component(s) 118 are coupled to one another via one or more wired or wireless connections. Example wired connections include, but are not limited to, traces and system buses connecting two or more of the processor 106, the controller 110, the memory 112, the clock generator 114, the voltage generator 116, and the other component(s) 118. Other example connections include optical connections, fiber optic connections, and/or connections or links based on quantum entanglement.

Examples of devices or apparatuses in which the system 100 is implemented include, but are not limited to, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The memory 112 is a device or system that is used to store information, such as for immediate use in a device, e.g., by the processor 106. In one or more implementations, the memory 112 corresponds to semiconductor memory where data is stored within memory cells on one or more integrated circuits. In at least one example, the memory 112 corresponds to or includes volatile memory, examples of which include random-access memory (RAM), dynamic random-access memory (DRAM), synchronous dynamic random-access memory (SDRAM), static random-access memory (SRAM), and memristors.

The memory 112 is packaged or configured in any of a variety of different manners. Examples of such packaging or configuring include a dual in-line memory module (DIMM), a small outline DIMM (SO-DIMM), a registered DIMM (RDIMM), a non-volatile DIMM (NVDIMM), a ball grid array (BGA) memory permanently attached to (e.g., soldered to) the motherboard (or other printed circuit board), and so forth.

Examples of types of DIMMs include, but are not limited to, synchronous dynamic random-access memory (SDRAM), double data rate (DDR) SDRAM, double data rate 2 (DDR2) SDRAM, double data rate 3 (DDR3) SDRAM, double data rate 4 (DDR4) SDRAM, and double data rate 5 (DDR5) SDRAM. In at least one variation, the memory 112 is configured as or includes a SO-DIMM or an RDIMM according to one of the above-mentioned standards, e.g., DDR, DDR2, DDR3, DDR4, and DDR5.

Alternatively or in addition, the memory 112 corresponds to or includes non-volatile memory, examples of which include flash memory, read-only memory (ROM), programmable read-only memory (PROM), erasable programmable read-only memory (EPROM), electronically erasable programmable read-only memory (EEPROM), and non-volatile random-access memory (NVRAM), such as phase-change memory (PCM) and magneto resistive random-access memory (MRAM). The memory 112 is configurable in a variety of ways that support task scheduling based on component margins in accordance with the described techniques.

Further examples of memory configurations include low-power double data rate (LPDDR), also known as LPDDR SDRAM, which is a type of synchronous dynamic random-access memory. In variations, LPDDR consumes less power than other types of memory and/or has a form factor suitable for mobile computers and devices, such as mobile phones. Examples of LPDDR include, but are not limited to, low-power double data rate 2 (LPDDR2), low-power double data rate 3 (LPDDR3), low-power double data rate 4 (LPDDR4), and low-power double data rate 5 (LPDDR5). It is to be appreciated that the memory 112 is configurable in a variety of ways without departing from the spirit or scope of the described techniques.

In accordance with the described techniques, the scheduler 102 is configured to schedule tasks 104 on the various components of the system 100 based on margins of those components. In one example scenario, for instance, the scheduler 102 receives a request 124 to perform one or more tasks 104. The scheduler 102 accesses a margin table 126, which includes margin information about the components on which the scheduler 102 is capable of scheduling tasks 104. The margin information describes for each component a margin relative to which the component is capable of operating without errors. The scheduler 102 accesses the margin table 126 to select a component based on the margin information and the one or more tasks 104 corresponding to the request 124. For example, the scheduler 102 selects which of the cores 108 to schedule a task 104 on based on the margin information in the margin table 126 and based on the task 104, such as whether the task 104 benefits more from being performed fast (e.g., video game graphics rendering) or being performed accurately (e.g., game physics). The scheduler 102 schedules performance of the task 104 on the selected component.

In one or more implementations, the controller 110 generates and/or updates the margin table 126, such as during a boot up process of the system 100. The controller 110 is also configured to dynamically update the margin table 126 during operation of the system 100, such as based on a request from an application or from a user to adjust a margin of one or more components, e.g., overclocking one or more of the cores 108 or a different component on the fly. In one or more implementations, the controller 110 causes the margin table 126 to be loaded and stored in the memory 112 for access by the scheduler 102. Alternatively or additionally, the margin table 126 is maintained in the controller 110 and is accessible to the scheduler 102 from the controller 110. In the illustrated example, the controller 110 includes testing logic 128. In at least one variation, the testing logic 128 is a portion of firmware which operates the controller and causes the controller 110 to determine the margins of one or more components of the system 100 and/or to test the margins of the components, e.g., to confirm them.

Examples of the one or more operations the controller 110 and/or another component of the system 100 (e.g., a physical layer (PHY)) perform on the components during a training process to determine and/or set margins include, but are not limited to, performing frequency, voltage, timing, and temperature adjustments. For example, one or more shmoos of a component pertinent frequency, component voltage, and temperatures are generated to establish operating points where errors (e.g., bit flips, cross talk, marginality of reads) begin and where the components lose functionality. As used herein, a “shmoo” refers to a plot or the act of generating a plot that indicates the results of testing one or more components of the system, e.g., a shmoo indicates a response of the component when conditions with which the component operates are varied. In at least one implementation, the controller 110 performs reference voltage (Vref) shmoos, delay-locked loop (DLL) shmoos, virtual timing and signal analysis (vTSA) tests, and/or different voltage and delay level adjustments to the components to adjust the operating parameters of the components. Additionally or alternatively, the controller 110 performs at least one of the Vref shmoos, DLL shmoos, vTSA tests, and voltage/delay level adjustments directly on the components. In one or more implementations, the controller 110 generates one or more eye diagrams of the components operating parameters using a combination (e.g., a multidimensional combination) of Vref and DLL shmoos. Based on the generated eye diagrams, for instance, the controller 110 obtains the margins at which the components are capable of performing. In variations, different operations are performed to identify the margins of the components without departing from the described techniques.

Based on such determinations the controller 110 generates or updates the margin table 126. For example, the controller 110 populates the margin table 126 with the determined margins, such as by populating a margin field or entry associated with a component with the component's determined (and tested) margin. Thus, in one or more implementations, the margin table 126 includes entries for each component that is accessible to the operating system 120 on which the scheduler 102 can schedule tasks 104, e.g., an identifier of the component. The margin table 126 also includes a margin field or entry for the margin of each component, and the margin field or entry is associated with the component entry, e.g., with the identifier. The margin of the components, as included in the margin table 126, are formattable in a variety of ways without departing from the spirit or scope of the techniques, an example of which is a percent, although other formats are usable in variations.

Based on the margin information (e.g., the margins of the components) stored in the margin table 126, the scheduler 102 schedules a task 104 on one or more of the various components. In at least one variation, for instance, the scheduler 102 causes a search for or look up of one or more components and obtains the respective margins, e.g., by directly accessing the margin table 126 and/or by using an application programming interface (API) to obtain the margin from the controller 110. With the obtained margin information, the scheduler 102 schedules the task 104 according to a scheduling algorithm 130. In one or more implementations, the scheduling algorithm 130 maps prioritized operating characteristics (e.g., whether speed or accuracy is a priority) to the components operating at margins that facilitate performing the task with such characteristics.

Broadly, the scheduler 102 assigns resources, i.e., the various components of the system 100, to perform the tasks 104. In one or more implementations, the scheduler 102 is a process of the operating system 120 implemented by the underlying scheduling algorithm 130 executing on a processor, such as the processor 106 and/or a processor in the memory 112, and the scheduler 102 communicates with the controller 110 via the operating system 120. For example, the controller 110 and the operating system 120 exchange communications formatted according to the Advanced Configuration and Power Interface (ACPI) specification. According to the scheduling algorithm 130, the scheduler 102 determines which tasks 104 to run at certain points in time and assigns the components to those tasks 104 so that the components perform the tasks 104. In one or more scenarios, the scheduler 102 is also configured to pause performance of tasks 104, move tasks 104 to a back of a queue, and start a new tasks 104.

In at least one variation, the scheduling algorithm 130 underlying the scheduler 102 is configured to achieve one or more goals, such as maximizing throughput (e.g., a total amount of work completed per time unit), minimizing wait time (e.g., an amount of time from work becoming ready until it begins execution), minimizing latency or response time (e.g., an amount of time from work becoming ready until it is finished or until the system 100 responds and hands an output to a user), maximizing accuracy (e.g., a number of errors introduced due to a component performing the task), and minimizing power usage, to name just a few. In operation, such goals often conflict (e.g., throughput versus latency and throughput versus accuracy), and so the scheduling algorithm 130 also includes rules and/or other heuristics for addressing such conflicts, e.g., priorities, conditional statements, etc.

Examples of tasks 104 for which accuracy is prioritized (e.g., critical) include but are not limited to disk input/output (I/O), network transactions, interrupt handling, web browser traffic, game physics, digital right management (DRM) applications, and non-gaming workloads, and so forth. By way of contrast, examples of tasks 104 which are not accuracy sensitive (complete accuracy is not critical) include but are not limited to game rendering, real-time transcoding, video streaming, and big-data processing using machine-learning models (e.g., neural networks), to name just a few. In other words, the tasks 104 that are not accuracy sensitive include those which have lossy algorithms as part of their logic. In some scenarios, at least one of the tasks 104 for which accuracy is not prioritized is a task for which speed (e.g., throughput) is prioritized, e.g., game rendering or video streaming. With respect to game rendering and video streaming, for instance, users are unlikely to notice missing pixels or incorrectly colored pixels in individual frames of a plurality of frames. If there is a delay in those frames, however, which affect a playback speed, the users are likely to notice which may potentially degrade a gaming and/or viewing experience.

In one or more implementations, the application 122 and/or the individual tasks 104 are associated with one or more performance objectives and/or a prioritization of performance objectives. Thus, in at least one variation, the scheduler 102 selects components for the tasks 104 based on a type of task. By way of example, a game physics task is associated with accuracy (or accuracy is prioritized over speed) and a game rending task is associated with speed (or speed is prioritized over accuracy). The scheduler 102 accesses this information when scheduling the tasks 104, and the scheduler 102 schedules the tasks 104 to the components with the margins that support the associated performance objective and/or the prioritization of performance objectives.

For a task 104 that is associated with accuracy, for instance, the scheduler 102 assigns components to the task 104 that have margins which support accurate performance of the task 104. Rather than assigning an overclocked component (e.g., one or more cores 108) to a task 104 associated with accuracy, for instance, the scheduler 102 is configured to assign a component with larger margin(s) to the task 104, e.g., the component operates within a certified stable window away from an operating point capable of or likely to introduce error.

For a task 104 that is associated with speed, though, the scheduler 102 assigns components to the task 104 that have margins which support fast performance of the task 104. For instance, the scheduler 102 assigns an overclocked component (e.g., an overclocked core 108 or at least a portion of a graphics processing unit (GPU) that is overclocked) to a task 104 that is associated with speed. In at least one variation, such components have smaller or negative margins, such that the components are likely to and, in some cases, guaranteed to introduce error, but those components are capable of higher throughput (e.g., supporting fast performance of the task 104). It is to be appreciated that some tasks 104 actually benefit from the introduction of random error, and assigning components operating in a way that is likely to or will introduce errors to those tasks improves an outcome of the task 104, examples of which include one or more machine learning operations.

To demonstrate that the system 100 includes components operating with high margins and low margins, such that the system 100 supports performing both tasks 104 having performance objectives served by performing them on high-margin components and tasks 104 having performance objectives served by performing them on low-margin components, the processor 106 is depicted with a subset 132 of the cores 108 configured for operating in an overclocked mode. The other cores 108 are configured for operating in a non-overclocked mode, such as within manufacturer certified bounds of stable operation. In one or more implementations, various other components of the system 100 support tasks 104 having performance objectives served by performing them on high-margin components and while others support tasks 104 having performance objectives served by performing them on low-margin components. In at least one variation, for example, the memory 112 is configured to operate in an overclocked mode and in a non-overclocked mode (e.g., it is switchable on the fly) to support both types of tasks 104. Alternatively or in addition, the system 100 includes multiple memories, such that at least one operates in an overclocked mode and at last one operates in a non-overclocked mode.

The application 122 and/or tasks 104 are associated with performance objectives and/or prioritizations of performance objectives in various ways. In one variation, for example, settings of an application 122 (e.g., in a settings file and specified by a developer) define performance objectives for the various tasks 104 of the application 122. Alternatively or additionally, a task mapping engine or other equivalent logic classifies the tasks 104 into groups corresponding to performance objectives and/or a prioritization of performance objectives. Thus, in one or more implementations, tasks 104 are classified dynamically, when the request 124 for those tasks is received, as being associated with accuracy, speed, some other performance objective, and/or a combination or prioritization of performance objectives. Alternatively or additionally, the request 124 includes an indication of the performance objective and/or a prioritization of such objectives. Alternatively or additionally, other information (e.g., packet headers) associated with the tasks 104 includes their performance objectives and/or prioritizations of those objectives. In one or more variations, the described techniques also allow a user, via one or more user inputs, to specify performance objectives for tasks 104, which are used by the scheduler 102 the tasks to the components that support those objectives.

In one or more implementations, this information is aggregated and stored, such as in a table that maps applications 122 and/or tasks 104 to performance objectives and/or prioritizations of performance objectives. In such implementations, the scheduler 102 accesses the information from storage (e.g., the stored table) to map those objectives to margins that support the objectives in order to assign the components of the system 100 to the tasks 104. In variations, the scheduler 102 the information is determined and/or received dynamically, such as when the scheduler 102 obtains the information as part of the request. In such implementations, the scheduler 102 maps the objectives (e.g., determined dynamically or received as part of the request 124) to margins that support the objectives in order to assign the components of the system 100 to the task 104.

As noted above, in variations, one or more components of the system 100 are adjustable “on the fly” to operate in different modes, such as an overclocked mode (e.g., supporting tasks 104 associated with speed) and a non-overclocked mode (e.g., supporting tasks 104 associated with accuracy).

By way of example, the controller 110 adjusts operation of the processor 106 (e.g., individual cores 108), the memory 112, and/or the other component(s) 118 in real time and without rebooting so that they operate according to different settings specified for one or more of processor overclocking, voltage droop detection and response, memory overclocking, and processor core configuration. Thus, when the scheduler 102 receives a request 124 to perform a particular task 104 using the system 100, in one or more variations, the scheduler 102 causes the controller 110 to adjust operation of components “on the fly” to operate in a manner that facilitates the task 104's performance objectives. This includes, for example, adjusting the processor 106 (e.g., one or more cores 108 of the processor 106) and/or the memory 112 on the fly to operate according to one or more overclocking settings for the processor 106 and/or the memory 112 associated with the task 104.

To do so, in one example, the controller 110 and/or another component of the system 100 (e.g., a physical layer (PHY)) are configured to set clock and/or power inputs to a component to cause the component to operate with different margins, e.g., in an overclocked mode versus a non-overclocked mode. For example, the controller 110 sends one or more adjustment signals 134 to the voltage generator 116 to adjust a supply voltage (e.g., VDD), such that the clock and power inputs to a component subsequently include the supply voltage as adjusted according to the adjustment signals 134. Additionally or alternatively, the controller 110 sends an adjustment signal 134 to the clock generator 114 to change a frequency of a clock rate, such that clock and power inputs to a component subsequently include a reference clock signal as adjusted according to the adjustment signals 134. The controller 110 is operable to adjust clock and power inputs to the components in various ways to produce an operative state that supports one or more performance objectives of a task or group of tasks.

Alternatively or additionally, the margin of one or more components of the system 100 (e.g., one or more of the cores 108 and/or the memory 112) is adjustable “on the fly.” For example, the margin is increased or decreased on demand. In a scenario where the margin of a component (e.g., a core 108 or the memory 112) is increased, the margin increase enables increased accuracy of the component, in exchange for decreased performance (e.g., throughput) of the component. By way of example, dynamically increasing the margin, and thus accuracy, is used in one or more scenarios where accurate computation is advantageous (or critical). By way of contrast, in a scenario where the margin of a component (e.g., a core 108 or the memory 112) is decreased, the margin decrease enables increased performance (e.g., throughput) of the component, in exchange for decreased accuracy. Dynamically decreasing the margin, and thus the performance (e.g., throughput) is used in one or more scenarios where higher performance is advantageous. In one or more implementations, the controller 110 and/or another component of the system 100 (e.g., a physical layer (PHY)) are configured to dynamically adjust (e.g., increase or decrease) the margins of components on demand or “on the fly.”

In an implementation example, for instance, the margins of overclocked cores (e.g., cores 108 that are overclocked) are adjusted dynamically to subsequently become (at least temporarily) efficiency cores. In at least one variation, any of the cores 108 are adjustable in this way. Alternatively or additionally, the cores that are adjustable are limited to one or more of the cores 108 that are less performant than at least one other core 108 of the system 100, such that the one or more less performant cores are relatively less performant when operating in an accurate and/or efficiency mode, but can be used to increase capacity when the system is heavily loaded and one or more tasks requiring no errors are being performed.

In one or more implementations, in order to inform the operating system 120 and thus the scheduler 102 about component margin information, the controller 110 formats communications with the operating system 120 according to a specification or standard associated with power configuration. Similarly, the operating system 120 formats communications (e.g., that originate from the scheduler 102) to the controller 110 according to such a specification or standard. In one or more implementations, the controller 110 and/or the operating system 120 format those communications according to the Advanced Configuration and Power Interface (ACPI) specification.

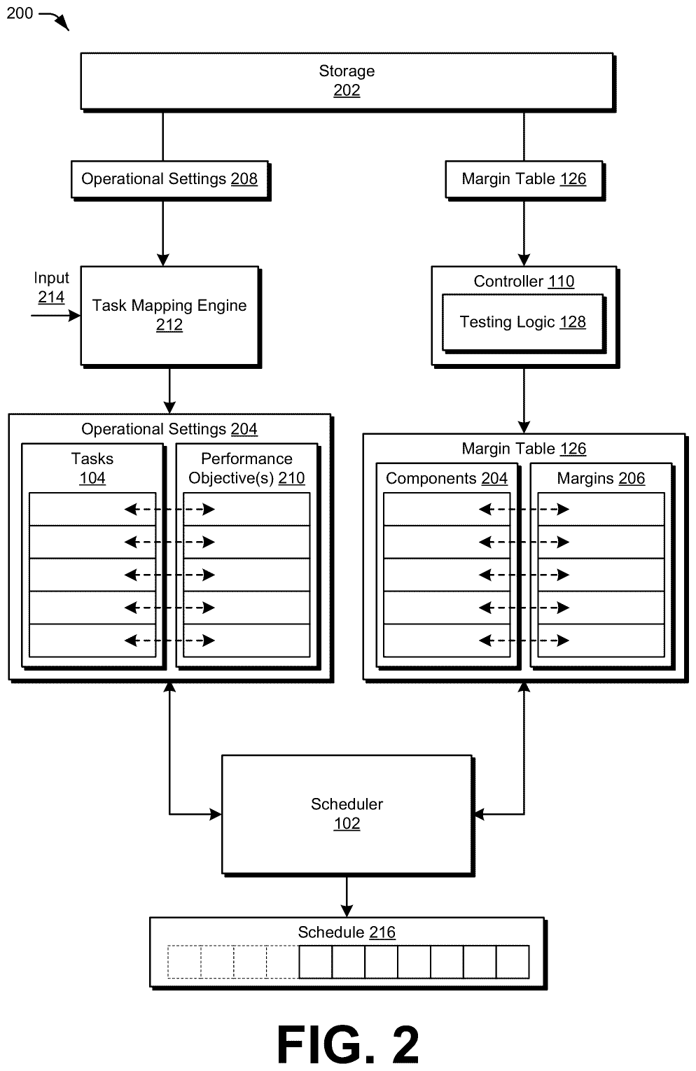

In the context of mapping performance objectives associated with tasks to margins of components support achieving those objectives, and then scheduling the components to the tasks based on the mapping, consider the following discussion of FIG. 2.

FIG. 2 is a block diagram of a non-limiting example 200 in which a scheduler schedules components to perform tasks based on a mapping of performance objectives associated with the tasks to margins that support achieving those objectives.

The illustrated example 200 includes the scheduler 102 and the controller 110. The illustrated example 200 also includes storage 202, an example of which is a data store such as a hard disk drive or other persistent storage. In at least one variation, the storage 202 is non-volatile storage, examples of which are mentioned above.

In this example 200, the controller 110 is depicted obtaining the margin table 126 from the storage 202. For example, the margin table 126 is initially retrieved from the storage 202 during boot up of the system 100. In variations, however, the controller 110 accesses the margin table 126 from elsewhere, such as from its own onboard storage where the margin table 126 is stored by the controller 110 and also updated by the controller 110.

The controller 110 is also depicted providing the margin table 126 to the scheduler 102. In one or more implementations, the controller 110 provides the margin table 126 to the scheduler 102 by causing the margin table 126 to be loaded into the memory 112 and thus accessible from the memory 112. Alternatively or in addition, the margin table 126 is available to the scheduler 102 from the controller 110, such through exchange of communications between the controller 110 and the operating system 120, e.g., according to the according to the Advanced Configuration and Power Interface (ACPI) specification.

In the illustrated example 200, the margin table 126 includes components 204 and margins 206. The components 204 in the margin table 126 include any one or more of the various components of the system 100 that are accessible to the operating system 120 for scheduling tasks 104 by the scheduler 102. The margin table 126 associates the margins 206 determined by or otherwise known to the controller 110 with the respective component 204. In one or more implementations, the controller 110 using the testing logic 128 to determine and/or confirm the margins of the components (e.g., during boot up) and populates the margin table 126, e.g., by populating margin fields of the margin table 126 with values corresponding to the margins of the respective components 204. For example, the components 204 include an entry for the memory 112 and the margins 206 include an associated entry for the margin(s) of the memory 112. In one or more implementations, the controller 110 populates the entry for margin(s) of the memory 112 with a value indicative of the memory 112's margin(s) determined and/or confirmed by the controller 110 using the testing logic. In variations, the margin table 126 is populated with the margins 206 of the components 204 in different ways without departing from the spirit or scope of the described techniques.

The illustrated example 200 also includes operational settings 208, which represent a mapping of the tasks 104 to performance objective(s) 210, which include prioritization of performance objectives in at least one variation. Alternatively or additionally, tasks 104 are mapped to performance objective(s) 210 using different mechanisms without departing from the spirit or scope of the described techniques. As discussed above, for example, in variations a performance objective is determined dynamically and provided as part of the request 124 and/or is included in a data packet corresponding to the task 104.

The illustrated example includes task mapping engine 212. In at least one variation, the task mapping engine 212 is a process of the operating system 120 and/or an application 122. Broadly, the task mapping engine 212 maps the tasks 104 to the performance objective(s) 210. The task mapping engine 212 maps the tasks 104 to the performance objective(s) 210 in any one or more of a variety of ways, examples of which include mapping the tasks 104 to the performance objective(s) 210 based on a type of the task, based on settings (e.g., of a corresponding application) which specify a performance objective(s) 210, using machine learning that correlates a task 104 with other tasks having commonalities based on historical data and that outputs performance objectives for the task 104 based on the correlated tasks, and so forth. In one or more variations, one or more of the tasks 104 is mapped to performance objective(s) 210 based on input 214, such as user input specifying a performance objective and/or prioritization of performance objectives or input from an application 122.

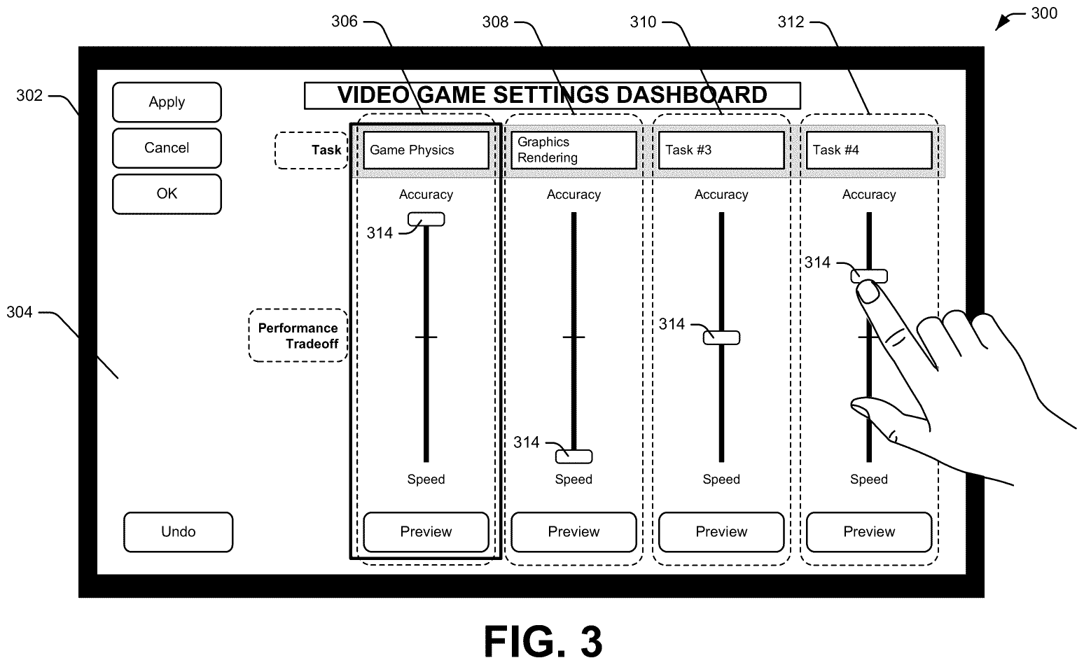

In accordance with the described techniques, the scheduler 102 generates and/or updates a schedule 216 for each component of the system 100. As discussed above and below, the scheduler 102 generates the schedule 216 by assigning the components to the tasks 104 based on the margins 206 of the components 204. In one or more implementations, the scheduler 102 assigns the components 204 to the tasks 104 by mapping or matching the performance objective(s) 210 with the margins 206 that support achieving those performance objective(s) 210, such as based on the scheduling algorithm 130. In the context of receiving user input to specify performance objective(s) 210 for tasks 104 consider FIG. 3.

FIG. 3 depicts a non-limiting example 300 of a user interface in one or more implementations. The example 300 includes a display device 302 outputting a user interface 304, which receives user input to adjust one or more performance objectives for one or more tasks. It is to be appreciated that user interfaces for adjusting performance objectives of tasks 104 and/or for more particularly specifying margins of components for performing the tasks are configurable in different ways without departing from the spirit or scope of the described techniques.

In this example 300, the user interface 304 presents identifiers 306, 308, 310, 312 of tasks 104, such as various tasks associated with an application 122, e.g., a video game. The user interface 304 also presents interactive elements 314 for each of the tasks 104. In one or more implementations, the interactive elements 314 are adjustable responsive to user input received in relation to the interactive elements 314 to specify one or more performance objectives for a respective task and/or prioritization of one or more performance objectives. In the illustrated example 300, the interactive elements 314 allow a user to provide user input to adjust a tradeoff between conflicting performance objectives, e.g., accuracy and speed.

Having discussed example systems and user interfaces for task scheduling based on component margins, consider the following example procedures.

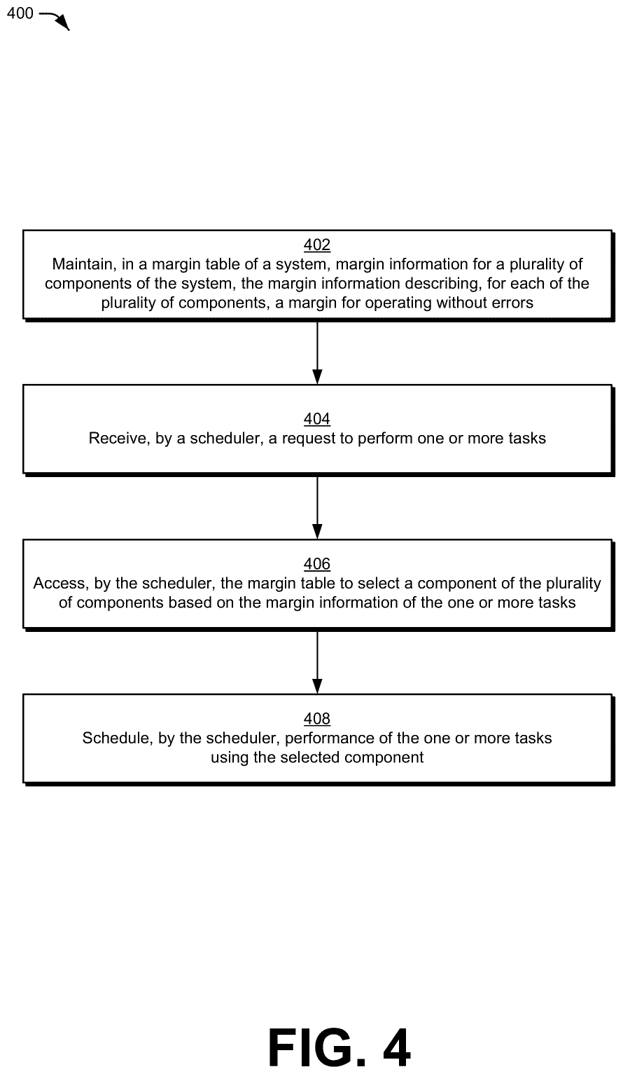

FIG. 4 depicts a procedure in an example 400 implementation of task scheduling based on component margins.

Margin information for a plurality of components of the system is maintained in a margin table of a system (block 402). In accordance with the principles discussed herein, the margin information describes, for each of the plurality of components, a margin for operating without errors. By way of example, a margin table 126 maintains margin information for a plurality of components (e.g., cores 108 of processor 106 and/or memory 112) of system 100. The margin information maintained in the margin table 126 describes for each component a margin relative to which the component is capable of operating without errors.

A request to perform one or more tasks is received by a scheduler (block 404). By way of example, the scheduler 102 is configured to schedule tasks 104 on the various components of the system 100 based on margins of those components. In one example scenario, for instance, the scheduler 102 receives a request 124 to perform one or more tasks 104.

The margin table is accessed, by the scheduler, to select a component of the plurality of components based on the margin information and the one or more tasks (block 406). By way of example, the scheduler 102 accesses the margin table 126 to select a component based on the margin information and the one or more tasks 104 corresponding to the request 124. For example, the scheduler 102 selects which of the cores 108 to schedule a task 104 on based on the margin information in the margin table 126 and based on the task 104, such as whether the task 104 benefits more from being performed fast (e.g., video game graphics rendering) or being performed accurately (e.g., game physics).

Performance of the one or more tasks is scheduled, by the scheduler, using the selected component (block 408). By way of example, the scheduler 102 schedules performance of the task 104 on the selected component.

It should be understood that many variations are possible based on the disclosure herein. Although features and controls are described above in particular combinations, each feature or control is usable alone without the other features and controls or in various combinations with or without other features and controls.

The various functional units illustrated in the figures and/or described herein (including, where appropriate, the processor 106 having the multiple cores 108, the controller 110, the memory 112, the clock generator 114, the voltage generator 116, the operating system 120, the applications 122, and the scheduler 102) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a margin table that maintains margin information for a plurality of components of the system, the margin information describing, for each of the plurality of components, a margin for operating without errors; and
a scheduler configured to:
receive a request to perform one or more tasks;
select a component of the plurality of components based on the margin information and the one or more tasks; and
schedule performance of the one or more tasks using the selected component.

2. The system of claim 1, wherein the scheduler is further configured to classify the one or more tasks as being associated with accuracy or performance.

3. The system of claim 2, wherein the scheduler selects the selected component with a high margin for operating without errors if the one or more tasks classified as being associated with accuracy.

4. The system of claim 2, wherein the scheduler selects the selected component with a low margin for operating without errors if the one or more tasks are classified as being associated with performance.

5. The system of claim 4, wherein the selected component with the low margin for operating without errors comprises an overclocked component.

6. The system of claim 1, wherein the scheduler is configured to classify the one or more tasks as being associated with accuracy or performance based on a type of the one or more tasks.

7. The system of claim 1, wherein the scheduler is further configured to initiate a test of the selected component prior to selecting the component to ensure that the margin of the selected component in the margin table is accurate.

8. The system of claim 1, wherein the plurality of components comprises a plurality of processing cores, wherein the plurality of processing cores includes at least one overclocked processing core.

9. The system of claim 1, wherein the selected component comprises at least one of a graphics processing unit (GPU) or a memory.

10. The system of claim 1, further comprising a controller to dynamically adjust a margin of a particular component of the plurality of components to perform at least one task using the particular component with the dynamically adjusted margin.

11. A computer-implemented method comprising:
maintaining, in a margin table of a system, margin information for a plurality of components of the system, the margin information describing, for each of the plurality of components, a margin for operating without errors;
receiving, by a scheduler, a request to perform one or more tasks;
selecting, by the scheduler, a component of the plurality of components based on the margin information of the one or more tasks; and
scheduling, by the scheduler, performance of the one or more tasks using the selected component.

12. The computer-implemented method of claim 11, further comprising classifying, by the scheduler, the one or more tasks as being associated with accuracy or performance.

13. The computer-implemented method of claim 12, further comprising selecting a component with a high margin for operating without errors if the one or more tasks are classified as being associated with accuracy.

14. The computer-implemented method of claim 12, further comprising selecting a component with a low margin for operating without errors if the one or more tasks are classified as being associated with performance.

15. The computer-implemented method of claim 14, wherein the selected component with the low margin for operating without errors comprises an overclocked component.

16. The computer-implemented method of claim 12, further comprising testing the selected component prior to selecting the component to ensure that the margin of the selected component in the margin table is accurate.

17. The computer-implemented method of claim 12, wherein the plurality of components comprises a plurality of processing cores, wherein the plurality of processing cores includes at least one overclocked processing core.

18. The computer-implemented method of claim 12, wherein the selected component comprises a graphics processing unit (GPU).

19. The computer-implemented method of claim 12, wherein the selected component comprises a memory.

20. A computing device comprising:
a plurality of processing cores, the plurality of processing cores including at least one overclocked processing core;
a margin table that maintains margin information for each of the plurality of processing cores, the margin information describing, for each of the plurality of processing cores, a margin for operating without errors; and
a scheduler configured to schedule a task using one of the plurality of processing cores based on the margin information maintained in the margin table.
